(19) United States
(12) Patent Application Publication
(10) Pub. No.: US 2026/0224062 A1
(43) Pub. Date: Aug. 6, 2026

(54) THERMALLY SENSITIVE CONTROL

(71) Applicant: Strix Limited, Ronaldsway, Isle of Man (GB)

(72) Inventors: Colin Moughton, Ronaldsway (GB); Ray Doyle, Ronaldsway (GB); Simon Cowell, Ronaldsway (GB); Jianshu Gao, Guangzhou (CN)

(21) Appl. No.: 19/147,933

(22) PCT Filed: Jan. 12, 2024
(86) PCT No.: PCT/EP2024/050736

§ 371 Date: Jul. 14, 2025

(30) Foreign Application Priority Data
Jan. 13, 2023 (CN) 202310070378.8
Mar. 15, 2023 (GB) 2303779.9

(51) Int. Cl. A47J 27/21; H01H 37/54

(52) U.S. Cl. CPC A47J 27/21116; A47J 27/2105; A47J 27/21158; H01H 37/5409; H01H 2037/5454

(57) ABSTRACT

A control unit for a liquid heating appliance including a leaf spring, which includes a fixed end and a moveable portion that is movable relative to the fixed end between a closed position and an open position is provided. The leaf spring includes a kink between the fixed end and the moveable portion. A moveable electrical contact is mounted on the moveable portion and mates with a corresponding fixed electrical contact in an electrical power supply circuit when the leaf spring is in the closed position. The control unit also includes a thermally sensitive actuator, operable at a predetermined temperature to move the leaf spring to the open position to separate the moveable contact from the fixed contact.

This application is entitled to the benefit of, and incorporates by reference essential subject matter disclosed in PCT Application No. PCT/EP2024/050736 filed on Jan. 12, 2024, which claims priority to GB Patent Application No. 2303779.9 filed Mar. 15, 2023 and CN Patent Application No. 202310070378.8 filed Jan. 13, 2023, which are hereby incorporated by reference in their entireties.

### BACKGROUND OF THE INVENTION

### 1. Technical Field

The present invention relates to a thermally sensitive control for a liquid heating appliance, a liquid heating appliance, a leaf spring, and a method of manufacturing a leaf spring.

### 2. Background Information

In liquid heating appliances, such as domestic kettles, an electrical heater is typically arranged to heat liquid stored within a liquid heating vessel of the appliance. Control units may be provided in order to control the provision of electrical power to the electrical heater, e.g. to initiate or terminate a heating operation.

Said control units often include a switch for disconnecting the electrical heater from the power supply when a predetermined temperature is sensed within the appliance. For example, the control unit may be arranged to turn off the electric heater when the liquid inside the liquid heating vessel has reached boiling (or a particular selected temperature) or when an overheat scenario is detected. Typically, control units comprise a thermally sensitive actuator (such as a snap-action bimetallic actuator) that operates at the predetermined temperature to move the switch to interrupt the power supply.

In some conventional control units, the switch comprises a leaf spring that carries a moveable electrical contact that is arranged to mate with a corresponding fixed electrical contact in the electrical power supply circuit for the heater. When the thermally sensitive actuator operates at the predetermined temperature, the leaf spring is deflected so that the electrical contacts are separated, thereby disrupting the supply of electrical energy to the heater. The electrical contacts are typically required to be separated by a minimum contact gap in order to avoid electrical arcing between the contacts when the contacts are separated following the operation of the thermally sensitive actuator.

It may be desirable to reduce the size of the control unit, as this can provide beneficial savings in manufacturing time and cost, and can also help to provide more freedom at the design stage of the liquid heating appliance. It can be expected that reducing the size of the control unit will typically necessitate a corresponding reduction in size of components within the control unit, such as the leaf spring. However, the minimum contact gap between the electrical contacts is typically the same, irrespective of the reduced size of the control unit.

When the length of the leaf spring is reduced, deflecting the leaf spring so as to provide a given required contact gap causes an increase in bending stresses within the leaf spring (in comparison with the stresses induced in a longer leaf spring). The increased stress, in combination with repeated deflections of the leaf spring during use of the appliance, can cause stress relaxation within the leaf spring.

This stress relaxation causes a reduction in contact force between the electrical contacts, which can lead to an increase in electrical resistance between the contacts which will worsen the effects of self-heating caused by carrying electrical current in the leaf spring. This may lead to further stress relaxation, a further increase in electrical resistance and thermal runaway characterized by issues such as fizzing contacts and control failure.

As a result, existing smaller control units are only suitable for appliances operating at low currents, and cannot safely be used in higher power appliances (e.g. between 13 and 15 amps).

The present invention aims to provide an improved control unit that can be made smaller than conventional control units without necessarily limiting its use to only low power appliances.

### SUMMARY

When viewed from a first aspect, the invention provides a control unit for controlling an electrical power supply circuit to an electrical heater in a liquid heating appliance, the control unit comprising: a leaf spring comprising a fixed end and a moveable portion that is moveable relative to the fixed end between a closed position and an open position; a moveable electrical contact, mounted on the moveable portion of the leaf spring, mating with a corresponding fixed electrical contact in the electrical power supply circuit when the leaf spring is in the closed position; a thermally sensitive actuator, operable at a predetermined temperature to move the moveable portion of the leaf spring from the closed position to the open position in which the moveable electrical contact is separated from the fixed electrical contact to interrupt the electrical power supply circuit; wherein the leaf spring comprises a kink between the fixed end and the moveable portion.

When viewed from a second aspect, the invention provides a liquid heating appliance comprising: a liquid heating vessel; an electrical heater for heating liquid contained within the liquid heating vessel, wherein the electrical heater is powered by an electrical power supply circuit; and a control unit comprising: a leaf spring comprising a fixed end and a moveable portion that is moveable relative to the fixed end between a closed position and an open position; a moveable electrical contact, mounted on the moveable portion of the leaf spring, mating with a corresponding fixed electrical contact in the electrical power supply circuit when the leaf spring is in the closed position; a thermally sensitive actuator, operable at a predetermined temperature to move the moveable portion of the leaf spring from the closed position to the open position in which the moveable electrical contact is separated from the fixed electrical contact to interrupt the electrical power supply circuit; wherein the leaf spring comprises a kink between the fixed end and the moveable portion.

It will be understood that the leaf spring is flexible such that the kink and moveable portion are deflected relative to the fixed end when the moveable portion moves between the closed position and the open position. Furthermore, it will be appreciated that as a leaf spring is substantially planar by definition, the kink can be understood as any deviation from the otherwise planar shape of the leaf spring.

Thus, the leaf spring provided by embodiments of the present invention has an increased effective bending length, owing to the presence of the kink, which allows the leaf spring to be shorter in its footprint length whilst helping to prevent the stress in the leaf spring from exceeding the yield stress of the material of the leaf spring. As a result, the entire control unit can be made smaller. This can reduce the cost of manufacturing the control unit, and can allow liquid heating appliances comprising the control unit to be made more visually appealing.

As the stress within the kinked leaf spring of the present invention can be reduced, in comparison with a conventional unkinked leaf spring having the same footprint length, the leaf spring of the present invention can, in some embodiments, carry higher currents (e.g., between 13 and 15 amps). As discussed above, leaf springs operating at high currents can suffer from worsened stress relaxation owing to the higher temperatures incurred in the leaf spring as a result of self-heating caused by the flow of electrical current through the leaf spring. The introduction of the kink to the leaf spring of the present invention allows the maximum bending stress in the leaf spring to be reduced, thereby helping to mitigate the effects of stress relaxation at high currents and to facilitate safe operation of the leaf spring below its yield stress.

In some embodiments, the liquid heating appliance is a cordless appliance. The control unit may comprise a cordless electrical adapter part for mating with a corresponding base electrical connector part, e.g. of a corresponding power base stand, to receive a supply of electrical power for the power supply circuit. The cordless electrical adapter part preferably comprises one or more mating conductors for connecting to a (respective) live or neutral pole of the corresponding base electrical connector part.

In some embodiments the control unit comprises a control body defining the cordless electrical adapter part. The control body may be a monolithic (e.g. molded) plastics material body. The cordless electrical adapter part and corresponding base electrical connector part may be of the type that can be mated regardless of their relative angular orientation, or at least through a wide angular range (e.g. at least 340° and preferably up to 360°). Suitable cordless connectors of this “360° type” are described in WO95/08024 and WO01/28294, and are available as the Strix P72 or P76 connector parts.

In some embodiments, the liquid heating appliance is arranged to be seated on a power base stand and the power base stand comprises the corresponding base electrical connector part. This base electrical connector part may include tabs for electrical connection to a mains power supply cable, or the mains power supply cable may be integrated with the connector part. Preferably the base electrical connector part is mounted centrally on the power base stand.

The cordless electrical adapter part located in the control unit may comprise at least two mating conductors, for connecting to the live and neutral poles of the power supply circuit. An additional earth connection may also be present. In some embodiments, the cordless electrical adapter part is a 3-pole connector part (e.g. for mating with a Strix P72). In other embodiments, the cordless electrical adapter part is a 5-pole connector part (e.g. for mating with a Strix P76). Such 5-pole connector parts provide for electronic signal connection as well as electrical power connection. Preferably the electrical power supply circuit of the liquid heating appliance is arranged to receive (e.g. from the base electrical connector part) an electrical current of between 13 and 15 amps.

Preferably the fixed end of the leaf spring is fixed to a mating conductor of the cordless electrical adapter part. The control unit preferably comprises two leaf springs, wherein a first of the leaf springs is connected or fixed to the live conductor of the cordless electrical adapter part and a second of the leaf springs is connected or fixed to the neutral conductor of the electrical adapter part. Any or all of the features of the leaf spring described herein can (and preferably do) apply to either or both of the first and second leaf springs, where provided.

For example, preferably the second leaf spring comprises a fixed end and a moveable portion that is moveable relative to the fixed end between a closed position and an open position. Preferably, the fixed end of the second leaf spring is fixed to the neutral mating conductor of the electrical adapter part. Preferably the second leaf spring extends substantially in a plane and comprises a kink, arranged between the fixed end and the moveable portion, which extends out of the plane and reverses to return substantially to the same plane. The second leaf spring is preferably between 0.05 mm and 0.18 mm thick, e.g. approximately 0.15 mm thick.

Preferably the fixed end of the (e.g. each) leaf spring is directly fixed to a (e.g. respective) mating conductor of the cordless electrical adapter part. The leaf spring(s) may be bonded to the mating conductor(s), e.g. by welding or soldering. The leaf spring(s) may be fixed to the mating conductor(s) by friction. The leaf spring(s) may be fixed to the mating conductor(s) by cooperation between a pair of fastening elements (e.g. a tab or hook and a corresponding aperture).

In some other embodiments, the liquid heating appliance comprises an electrical power socket for receiving an electrical power cord for connecting to a mains electrical power supply. In some embodiments, the liquid heating appliance comprises an integrated power cord.

In various embodiments, the liquid heating appliance may comprise a heat diffuser plate arranged in thermal communication with the electrical heater. Preferably the control unit is arranged to be mounted to an underside of the heat diffuser plate. In some embodiments, the control unit comprises a mount plate for mounting the control unit to the underside of the heat diffuser plate. The mount plate is preferably metal. The mount plate is preferably substantially flat.

The thermally sensitive actuator is preferably arranged to detect a temperature within the liquid heating appliance. The temperature may be representative of the temperature of the liquid within the liquid heating vessel. The temperature may be the temperature of the electrical heater. The temperature may be the temperature of the heat diffuser plate.

The predetermined temperature may be variable (e.g. adjustable). The predetermined temperature may correspond to a desired temperature for the liquid in the liquid heating volume to be heated to. The predetermined temperature may correspond to a desired state for the liquid in the liquid heating volume (e.g. boiling). In some embodiments, the predetermined temperature corresponds to a temperature within the appliance (e.g. a temperature of the heat diffuser plate) during an overheat (e.g. “dry-boil”) scenario.

In some embodiments, the control unit comprises an ‘overheat’ thermally sensitive actuator and a ‘liquid-temperature-condition’ thermally sensitive actuator. The overheat thermally sensitive actuator is preferably arranged to operate at a predetermined temperature corresponding to a temperature within the appliance during an overheat scenario. The liquid-temperature-condition thermally sensitive actuator is preferably arranged to operate at a predetermined temperature corresponding to a desired state for the liquid in the liquid heating volume (e.g. boiling).

Preferably both the overheat thermally sensitive actuator and the liquid-temperature-condition thermally sensitive actuator are arranged to move the moveable portion of the leaf spring from the closed position to the open position in which the moveable electrical contact is separated from the fixed electrical contact to interrupt the electrical power supply circuit.

In such embodiments, in which the control unit comprises both an ‘overheat’ thermally sensitive actuator and a liquid-temperature-condition thermally sensitive actuator, the control unit may be considered an “integrated” control.

In some embodiments, the control unit does not comprise a liquid-temperature-condition thermally sensitive actuator. Instead, the control unit may comprise only an overheat thermally sensitive actuator. A control unit in accordance with such embodiments may be suitable for use in a liquid heating appliance comprising an electrical switching arrangement that is physically separate from, but electrically connected to, the control unit. The electrical switching arrangement preferably comprises a liquid-temperature-condition thermally sensitive actuator for opening the switch so as to interrupt the supply of power to the heater. The liquid temperature-condition thermally sensitive actuator is preferably arranged to open the switch when a predetermined temperature is detected corresponding to a desired state for the liquid in the liquid heating volume (e.g. boiling).

Such a liquid heating appliance may be considered a “split-switch” appliance, as the switch for interrupting the supply of power to the heater in an overheat scenario is separate to the switch for interrupting the supply of power to the heater when a liquid temperature condition (e.g. boiling) is detected. By contrast, in an integrated control, the same switch (i.e. the same set of contacts in the control unit) is opened in both cases. The liquid-temperature-condition thermally sensitive actuator may comprise a thermomechanical, e.g. a bimetallic, switch. In some embodiments, the electrical switching arrangement comprises an electronic switching arrangement, for example comprising a controller connected to a thermistor. The electrical switching arrangement is preferably arranged in a different part of the liquid heating appliance to the control. This may improve the design flexibility for the liquid heating appliance. In some embodiments, the control unit is arranged in a base of the appliance and the electrical switching arrangement is arranged in an upper portion of the appliance (e.g. on a handle of the appliance). The electrical switching arrangement is preferably in series with the switch comprising the moveable electrical contact and the fixed electrical contact of the control unit.

In some embodiments (e.g. in which the control unit is an integrated control unit), the control unit comprises a trip lever. The trip lever is preferably movable (e.g. pivotable). The trip lever is preferably movable so as to act on and move the moveable portion of the leaf spring from the closed position to the open position in which the moveable electrical contact is separated from the fixed electrical contact to interrupt the electrical power supply circuit. The liquid-temperature-condition thermally sensitive actuator is preferably arranged to move the trip lever at the predetermined temperature. The liquid-temperature-condition thermally sensitive actuator is preferably arranged to move the trip lever so as to move the moveable portion of the leaf spring from the closed position to the open position in which the moveable electrical contact is separated from the fixed electrical contact to interrupt the electrical power supply circuit.

Preferably the (e.g. overheat) thermally sensitive actuator is mounted on an upper surface of the control unit. Preferably the thermally sensitive actuator is mounted on an upper surface of the mount plate. This means that, when the control unit is mounted to the underside of the heat diffuser plate, the thermally sensitive actuator can be arranged in good thermally conductive communication with the heat diffuser plate. As a result, the thermally sensitive actuator may be able to more reliably detect the predetermined temperature, e.g. by accurately detecting the temperature of the heat diffuser plate (and thus, e.g., the temperature of the liquid within the appliance). This can allow the thermally sensitive actuator to operate more reliably at the predetermined temperature.

The thermally sensitive actuator may comprise a bimetallic element. The bimetallic element is preferably a snap-action bimetallic actuator. Preferably the bimetallic element is arranged to operate (e.g. snap) when a predetermined temperature is detected.

The bimetallic element may act on the leaf spring directly. Preferably, however, the control unit (e.g. the thermally sensitive actuator) comprises an intermediate component that is operated on by the bimetallic element at the predetermined temperature to move the moveable portion of the leaf spring from the closed position to the open position. The bimetallic element preferably comprises an actuating portion that is arranged to deflect at the predetermined temperature. The actuating portion is preferably arranged to act on the intermediate component to move the intermediate component. Preferably the intermediate component is moved by the same distance through which the actuating portion of the bimetallic element deflects.

In preferred embodiments, the intermediate component comprises a push rod that is operated on by the (e.g. bimetallic) actuator at the predetermined temperature to move the moveable portion of the leaf spring from the closed position to the open position. Preferably the push rod extends downwardly from the thermally sensitive actuator towards the moveable portion of the leaf spring.

In some embodiments, the (e.g. push rod of the) thermally sensitive actuator is arranged to push against a contact point of the moveable portion of the leaf spring to move the moveable portion from the closed position to the open position. Preferably the contact point is arranged at a distal point of leaf spring relative to the fixed end and the moveable electrical contact. Preferably the moveable electrical contact is mounted on the moveable portion of the leaf spring between the kink and the contact point.

The distance travelled by the moveable portion of the leaf spring at the contact point is preferably substantially equal to the deflection of the actuating portion of the bimetallic element.

It may be beneficial for a manufacturer to use the same thermally sensitive actuator for a small control unit as for other (larger) sizes of control unit, in order to save costs and minimize design effort. However, owing to the reduced length of the leaf spring in conventional smaller controls, this is often not possible, as the force exerted by the thermally sensitive actuator on the shorter leaf spring will cause the stresses within the leaf spring to exceed the yield stress. However, as discussed herein, the provision of a kink in the leaf spring of the present invention can reduce the maximum stress within the leaf spring. Therefore, in some embodiments, the thermally sensitive actuator provided in the control unit to act on the leaf spring can beneficially be of the same dimensions as the type used in larger controls.

Furthermore, by arranging the (e.g. push rod of the) thermally sensitive actuator such that the distance from the fixed end of the leaf spring to the contact point is greater than the distance from the fixed end to the moveable electrical contact, the vertical displacement of the (e.g. push rod of the) thermally sensitive actuator at the contact point can result in a scaled down vertical distance at the position of the electrical contacts, i.e. where the contact gap is achieved. The position of the contact point between the (e.g. push rod of the) thermally sensitive actuator and the movable portion of the leaf spring can be selected at the design stage to provide the desired separation distance between the moveable electrical contact and the fixed electrical contact, for a given vertical displacement of the thermally sensitive actuator, when the moveable portion of the leaf spring is moved to the open position.

In some embodiments, the leaf spring defines an aperture in which the moveable electrical contact is arranged. The moveable electrical contact may be arranged within the aperture by an interference fit. Preferably, the leaf spring comprises an (e.g. integral) protrusion that extends out of the plane of the leaf spring around the perimeter of the aperture. This means that there is a greater contact area between the leaf spring and the moveable electrical contact, compared to the contact area that would be present if the leaf spring did not comprise the protrusion. This can improve the bond (e.g. cold bond) between the moveable electrical contact and the leaf spring, thereby helping to reduce self-heating (and the resultant stress) in the leaf spring.

This arrangement for mounting the moveable electrical contact may be particularly beneficial for leaf springs that are thinner than conventional leaf springs (i.e. less than 0.2 mm thick), as conventional methods of mounting electrical contacts to leaf springs (e.g. welding or riveting) are difficult to achieve at such low thicknesses.

This is considered to be novel and inventive in its own right. Thus, from a further aspect, the invention provides a leaf spring comprising: a proximal end and a distal portion that is moveable relative to the proximal end; and an electrical contact, mounted on the distal portion of the leaf spring, for mating with a corresponding electrical contact; wherein the leaf spring defines an aperture in which the electrical contact is arranged, and wherein the leaf spring comprises a protrusion that extends out of the plane of the leaf spring around the perimeter of the aperture to surround the electrical contact.

When viewed from a further aspect, the invention provides a control unit for controlling an electrical power supply circuit to an electrical heater in a liquid heating appliance, the control unit comprising: a leaf spring comprising a fixed end and a moveable portion that is moveable relative to the fixed end between a closed position and an open position; a moveable electrical contact, mounted on the moveable portion of the leaf spring, mating with a corresponding fixed electrical contact in the electrical power supply circuit when the leaf spring is in the closed position; a thermally sensitive actuator, operable at a predetermined temperature to move the moveable portion of the leaf spring from the closed position to the open position in which the moveable electrical contact is separated from the fixed electrical contact to interrupt the electrical power supply circuit; wherein the leaf spring defines an aperture in which the moveable electrical contact is arranged, and wherein the leaf spring comprises a protrusion that extends out of the plane of the leaf spring around the perimeter of the aperture.

When viewed from a further aspect, the invention provides a liquid heating appliance comprising: a liquid heating vessel; an electrical heater for heating liquid contained within the liquid heating vessel, wherein the electrical heater is powered by an electrical power supply circuit; and a control unit comprising: a leaf spring comprising a fixed end and a moveable portion that is moveable relative to the fixed end between a closed position and an open position; a moveable electrical contact, mounted on the moveable portion of the leaf spring, mating with a corresponding fixed electrical contact in the electrical power supply circuit when the leaf spring is in the closed position; a thermally sensitive actuator, operable at a predetermined temperature to move the moveable portion of the leaf spring from the closed position to the open position in which the moveable electrical contact is separated from the fixed electrical contact to interrupt the electrical power supply circuit; wherein the leaf spring defines an aperture in which the moveable electrical contact is arranged, and wherein the leaf spring comprises a protrusion that extends out of the plane of the leaf spring around the perimeter of the aperture.

When viewed from a further aspect, the invention provides a method of manufacturing a leaf spring comprising a proximal end and a distal portion that is moveable relative to the proximal end, the method comprising: forming an aperture through the distal portion of the leaf spring; and mounting the electrical contact on the distal portion of the leaf spring by inserting the electrical contact into the aperture; wherein forming the aperture comprises forming a protrusion that extends out of the plane of the leaf spring around the perimeter of the aperture.

As mentioned above, in some embodiments the moveable electrical contact may be arranged within the aperture by an interference fit. Preferably, the leaf spring comprises an (e.g. integral) protrusion that extends out of the plane of the leaf spring around the perimeter of the aperture. This means that there is a greater contact area between the leaf spring and the moveable electrical contact, compared to the contact area that would be present if the leaf spring did not comprise the protrusion.

In some embodiments, the leaf spring comprises a kink (e.g. having the features of any one or more embodiments of the other aspects discussed herein). However, the leaf spring may be substantially flat (e.g. at least between the proximal end and the distal portion). Preferably the leaf spring is less than 0.2 mm thick. In some embodiments the leaf spring is between 0.05 mm and 0.18 mm thick. In some embodiments the leaf spring is approximately 0.15 mm thick.

The leaf spring and the protrusion may be separate components. However, the leaf spring is preferably a monolithic component comprising the protrusion. The protrusion is preferably formed of the same material as the leaf spring. The protrusion is preferably formed at the same time as forming the aperture (e.g. by the same operation). This may simplify the manufacturing process for the leaf spring whilst helping to ensure that the beneficial geometry of the aperture and protrusion, as discussed above, is provided.

For example, the aperture may be formed by punching, which preferably causes the material of the leaf spring around the perimeter of the aperture to deflect in the direction of punching so as to form the protrusion. Thus, in some embodiments, the method may comprise forming the aperture by punching through the leaf spring to form the protrusion.

The protrusion may extend around a portion of the aperture. Preferably, the protrusion extends around the majority of the (e.g. the entire) perimeter of the aperture. The protrusion may be formed to surround the electrical contact.

In embodiments of any aspect disclosed herein, the movable portion of the leaf spring is preferably biased into the closed position. The bias may be provided by a separate component, i.e. a biasing member. However, preferably the bias is provided by the form of the leaf spring itself. The thermally sensitive actuator is preferably operable to move the moveable portion against this bias when moving the moveable portion from the closed position to the open position. After operating to move the moveable portion from the closed position to the open position, the thermally sensitive actuator is preferably arranged to reset so as to allow the movable portion to return to the closed position. The thermally sensitive actuator may be manually reset. However, preferably the thermally sensitive actuator is arranged to reset automatically (e.g. when the temperature detected by the thermally sensitive actuator drops sufficiently below the predetermined temperature).

In some embodiments, the control unit further comprises a trip lever for allowing a user to manually move the moveable portion of the leaf spring from the closed position to the open position and/or from the open position to the closed position. The trip lever may be moveable between an “OFF” position and an “ON” position. In the “ON” position, the moveable electrical contact is preferably in contact with the fixed electrical contact. In the “OFF” position, the moveable electrical contact may or may not be in contact with the fixed electrical contact. However, preferably the control unit is configured such that no electrical current flows through the electrical contacts when the trip lever is in the “OFF” position. Thus, the provision of a trip lever can allow a user to manually interrupt a heating operation of the liquid heating appliance and/or to initiate a heating operation.

As discussed above, the trip lever may also be arranged to be moved by a liquid-temperature-condition thermally sensitive actuator of the control unit (e.g. when boiling is detected).

Preferably the control unit comprises a stop for arresting the movement of the moveable portion of the leaf spring after the moveable portion has moved from the closed position to the open position. The moveable portion of the leaf spring is preferably arranged to contact the stop after moving from the closed position to the open position. Thus, the stop can be provided to limit the overshoot distance travelled by the moveable portion of the leaf spring. This can help to prevent the leaf spring from plastically deforming as a result of (e.g. repeated) deflection in use.

In some embodiments, the stop is arranged on the control body of the control unit. In some embodiments, the stop is arranged on the trip lever of the control unit. When the stop is arranged on the trip lever of the control unit, the position of the trip lever may be reset (e.g. to the “OFF” position) by the force exerted by the moveable portion of the leaf spring on the stop when the moveable portion contacts the stop. Thus, the stop can act as a force transfer pad to provide a dual function of both resetting the trip lever's position and reducing overshoot in the leaf spring.

Preferably the stop is arranged (e.g. directly) vertically below the contact point (i.e. the point at which the thermally sensitive actuator, or push rod thereof, contacts the leaf spring). Positioning the stop directly below the contact point means that the leaf spring may be brought to a stop more quickly and without inducing a bending moment in the leaf spring between the stop and the contact point. Such a bending moment can damage the leaf spring.

In some embodiments, the control unit comprises a return stop for arresting the movement of the moveable portion of the leaf spring from the open position towards the closed position (e.g. after the moveable portion has been moved by the thermally sensitive actuator into the open position, and as it returns towards the closed position under its own bias). The return stop is preferably arranged to prevent the leaf spring from returning to the closed position after the moveable portion has been moved to the open position. The return stop is preferably arranged on the trip lever of the control unit.

In some embodiments, the trip lever comprises a stop (e.g. a force transfer pad) and a return stop. The stop (e.g. force transfer pad) is preferably arranged below the moveable portion of the leaf spring (i.e. in the direction in which the moveable portion is moved by the thermally sensitive actuator). The return stop is preferably arranged above the moveable portion of the leaf spring.

The return stop may be arranged to move the moveable portion of the leaf spring from the closed position to the open position when the trip lever is moved from the ‘ON’ position to the ‘OFF’ position (e.g. by a user or by the operation of the liquid-temperature-condition thermally sensitive actuator).

Preferably, the trip lever is arranged such that movement of the trip lever from the ‘OFF’ position to the ‘ON’ position releases the moveable portion of the leaf spring so that the moveable portion can move from the open position to the closed position (e.g. as a result of the bias of the leaf spring). Preferably movement of the trip lever from the ‘OFF’ position to the ‘ON’ position does not directly move the moveable portion of the leaf spring such that the moveable electrical contact is brought into contact with the fixed electrical contact. For example, preferably the range of motion of the stop (when the trip lever is moved) is insufficient for the stop to move the moveable portion of the leaf spring directly such that the moveable electrical contact is brought into contact with the fixed electrical contact. This can help to improve safety by preventing a user from being able to override the control unit by manually closing the electrical contacts before the thermally sensitive actuator has reset. Preferably the moveable portion is moved from the open position to the closed position by the bias of the leaf spring alone.

The leaf spring is preferably a single homogenous component, preferably including at least the fixed end, the moveable portion and the kink. Preferably the leaf spring is elongate. The leaf spring is preferably mounted in the control unit as a cantilever, i.e. fixed at its fixed (proximal) end and unsupported (preferably moveable) at its opposite (distal) end. The kink may be spaced away from the fixed end by a further moveable portion of the leaf spring. However, preferably the kink is arranged adjacent the fixed end of the leaf spring. Preferably the kink is arranged at the point of deflection of the leaf spring. The point of deflection is the point of the leaf spring that is closest to the fixed end yet deflects when the moveable portion moves relative to the fixed end. Arranging the kink at the point of deflection of the leaf spring helps to reduce the stress in the leaf spring at the point of deflection, which is typically the most highly stressed portion of the leaf spring. Reducing the stress in this area can increase the durability of the leaf spring.

The kink may be any suitable or desired shape to provide an increased effective bending length. Preferably the kink extends out of the plane of the leaf spring and returns substantially to the same plane. The kink may be arcuate. The kink may be substantially semi-circular. The kink may be “U” shaped, “S” shaped, “V” shaped, “W” shaped, “M” shaped or “C” shaped. The kink may be substantially sinusoidal. The kink may include a folded portion. Preferably the kink is continuously curved. The kink may have the approximate shape of a normal distribution (bell) curve. Preferably the kink comprises an arcuate portion. Preferably the leaf spring comprises one or more continuously curved transition features (e.g. fillets) between the substantially planar leaf spring and the (e.g. arcuate portion of the) kink. This helps to avoid high stress concentrations in the leaf spring, which can allow the leaf spring to be made smaller without exceeding the yield stress of the leaf spring material.

As discussed above, by providing a kink in the leaf spring to increase the effective bending length of the leaf spring, the stress within the leaf spring can be reduced for a leaf spring of a given footprint length. As a result, the leaf spring can be made smaller without exceeding the yield stress of the material of the leaf spring.

The leaf spring of the present invention is considered to be novel and inventive in its own right. Thus, when viewed from a further aspect, the invention provides a leaf spring comprising: a proximal end and a distal portion that is moveable relative to the proximal end; and an electrical contact, mounted on the distal portion of the leaf spring, for mating with a corresponding electrical contact; wherein the leaf spring comprises a kink between the proximal end and the distal portion.

When viewed from a further aspect, the invention provides a method of manufacturing a leaf spring comprising a proximal end and a distal portion that is moveable relative to the proximal end; the method comprising: forming a kink in the leaf spring between the proximal end and the distal portion; and mounting an electrical contact, for mating with a corresponding electrical contact, on the distal portion of the leaf spring.

In some embodiments, the method of manufacturing the leaf spring comprises forming an aperture through the distal portion of the leaf spring. The method preferably comprises mounting the electrical contact on the distal portion of the leaf spring by inserting the electrical contact into the aperture. The electrical contact may be press-fit into the aperture. The step of forming the aperture may comprise punching the aperture. Preferably, forming the aperture comprises forming a protrusion that extends out of the plane of the leaf spring around the perimeter of the aperture. As explained above, this can increase the contact area between the electrical contact and the leaf spring, thereby helping to improve the bond (e.g. cold bond) between the electrical contact and the leaf spring.

The proximal end of the leaf spring is preferably suitable for mounting on a control unit of a (e.g. domestic) liquid heating appliance. Preferably the electrical contact is suitable for mating with a corresponding electrical contact in a control unit of a (e.g. domestic) liquid heating appliance.

The leaf spring may comprise one or more fillets arranged adjacent the kink to blend the geometry of the kink with the geometry of the rest of the leaf spring. In some embodiments, the kink comprises an arcuate portion arranged between two fillets. Preferably the arcuate portion of the kink has a radius of curvature of between 0.3 mm and 1.5 mm, e.g. between 0.5 mm and 1.0 mm, e.g. approximately 0.8 mm. Preferably the one or more fillets of a radius of curvature of between 0.1 mm and 1.35 mm, e.g. between 0.35 mm and 0.8 mm, e.g. approximately 0.65 mm.

The leaf spring may be any suitable or desired length. However, in preferred embodiments, the footprint length of the leaf spring is less than 25 mm. This allows the leaf spring to be used in control units that are smaller than conventional control units. The leaf spring may be between 5 mm and 30 mm, e.g. 15 mm and 25 mm, e.g. approximately 22 mm in (footprint) length. The leaf spring may be between 1.5 mm and 5 mm, e.g. between 2.0 mm and 4.0 mm, e.g. approximately 3.5 mm wide.

The leaf spring may be any suitable or desired thickness. However, in preferred embodiments, the thickness of the leaf spring is less than 0.2 mm. Reducing the thickness of the leaf spring can increase the effects of self-heating of the leaf spring, as a smaller cross-sectional area is provided for the current flowing through the leaf spring. However, the Applicant has identified that reducing the thickness of the leaf spring can also reduce the stresses incurred in the leaf spring. This means that the leaf spring can be made shorter still before the yield stress of the material is exceeded. The leaf spring may be between 0.05 mm and 0.3 mm thick, e.g. between 0.1 mm and 0.2 mm thick, e.g. approximately 0.15 mm thick. Preferably the leaf spring has a cross-sectional area in a plane perpendicular to the maximum dimension (i.e. length) of the leaf spring of between 0.07 mm² and 1.5mm² , e.g. between 0.2 mm² and 0.8mm² , e.g. approximately 0.5mm^{2 .}

In some embodiments the leaf spring is between 0.05 mm and 0.18 mm thick, e.g. between 0.1 mm and 0.15 mm thick, e.g. approximately 0.15 mm thick.

Preferably, when the moveable portion of the leaf spring is in the open position, the moveable electrical contact is separated from the fixed electrical contact by a contact gap of between 0.3 mm to 1.5 mm, e.g. 0.7 mm to 1.2 mm, e.g. approximately 0.9 mm. This separation distance may be the minimum distance required in order to avoid electrical arcing between the contacts when the moveable portion moves between the closed and open positions. The leaf spring is preferably shaped such that, when the leaf spring is arranged within the control and the moveable electrical contact is in the closed position, the deflection in the leaf spring provides a pre-load force that is applied to the fixed electrical contact by the moveable electrical contact. In preferred embodiments, when the moveable portion is in the closed position, the leaf spring is arranged such that the moveable electrical contact exerts between 10 grams and 30 grams of pre-load, e.g. between 15 grams and 25 grams of pre-load, e.g. approximately 20 grams of pre-load on the fixed electrical contact.

The leaf spring may be made from any suitable or desired material. Preferably the leaf spring is electrically conductive, e.g. metallic. In preferred embodiments, the leaf spring material is a (e.g. hardened) copper alloy, e.g. C7025.

It will be appreciated that any aspect described herein may (and preferably does) include one or more (e.g. all) of the optional and preferred features outlined herein.

### BRIEF DESCRIPTION OF THE DRAWINGS

Certain preferred embodiments of the invention will now be described, by way of example only, with reference to the accompanying drawings, in which:

FIG. 1 shows a perspective view of a liquid heating appliance in accordance with an embodiment of the present invention;

FIGS. 2A and 2B show perspective views of the control unit of the liquid heating appliance of FIG. 1;

FIG. 3 shows a cross-sectional front view of the control unit of FIGS. 2A and 2B;

FIG. 4 shows a perspective view of various component parts of the control unit of FIGS. 2A and 2B;

FIG. 5A, FIG. 5B and FIG. 5C show cross-sectional front views of the leaf spring of the control unit of FIGS. 2A and 2B when operated on by the push rod of the control unit;

FIGS. 6A and 6B show cross-sectional front views of the leaf spring of the control unit of FIGS. 2A and 2B when operated on by the trip lever of the control unit;

FIG. 7 is a graph showing the von Mises stress in conventional leaf springs of different lengths;

FIG. 8 shows a cross-sectional front view of a control unit of a liquid heating appliance in accordance with another embodiment of the present invention;

FIG. 9A and FIG. 9B show cross-sectional front views of a leaf spring of the control unit of FIG. 8;

FIG. 10 shows a perspective view of a ‘split-switch’ liquid heating appliance in accordance with an embodiment of the present invention;

FIG. 11A shows a front view of a leaf spring of the control unit of FIG. 8;

FIG. 11B shows a front view of a leaf spring of a control unit of a liquid heating appliance in accordance with another embodiment of the present invention; and

FIG. 12A, FIG. 12B, FIG. 12C and FIG. 12D show alternative geometries for the kink of the leaf spring.

### DETAILED DESCRIPTION

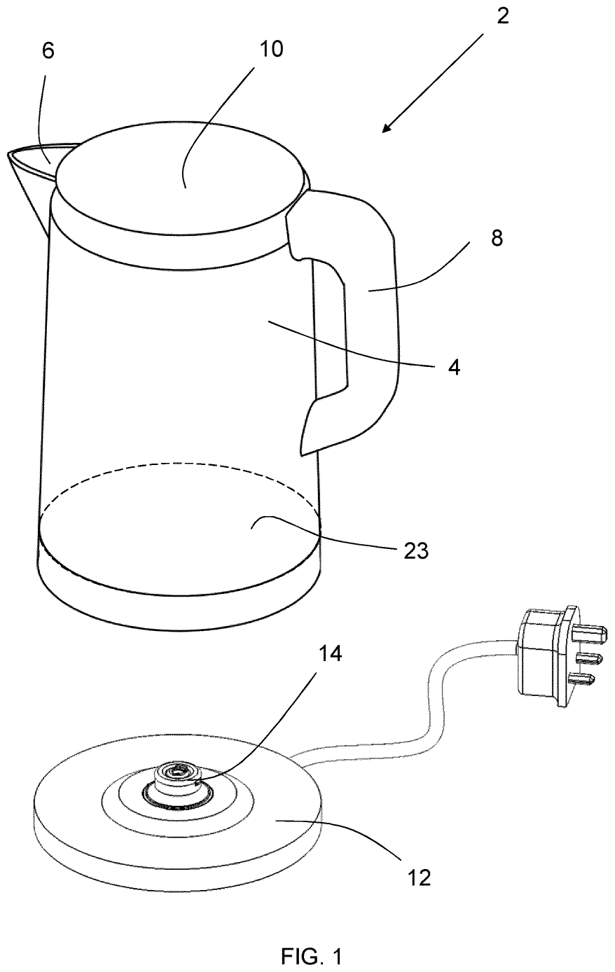

FIG. 1 shows a perspective view of a liquid heating appliance 2, hereinafter the appliance 2, in accordance with an embodiment of the present invention. The appliance 2 comprises a liquid heating vessel 4, a spout 6 and a handle 8. The top of the appliance 2 is closed with a lid 10. The appliance 2 is arranged to rest on a power base 12 having a 360-degree base electrical connector part 14 provided in the center for supplying the appliance with electricity.

The appliance 2 further comprises an electrical heater (not shown in FIG. 1) for heating a volume of liquid contained within the liquid heating vessel 4. The heater comprises an electrical heating element mounted to the underside of a heat diffuser plate. The heating element is arranged in conductive thermal communication with the base 23 of the liquid heating vessel 4 via the heat diffuser plate when electrical energy is provided to the heater, thereby heating the contents of the liquid heating vessel 4.

A control unit (not shown in FIG. 1) is also mounted to the underside of the heat diffuser plate, and controls the provision of electrical power from the power base 12 to the electrical heater.

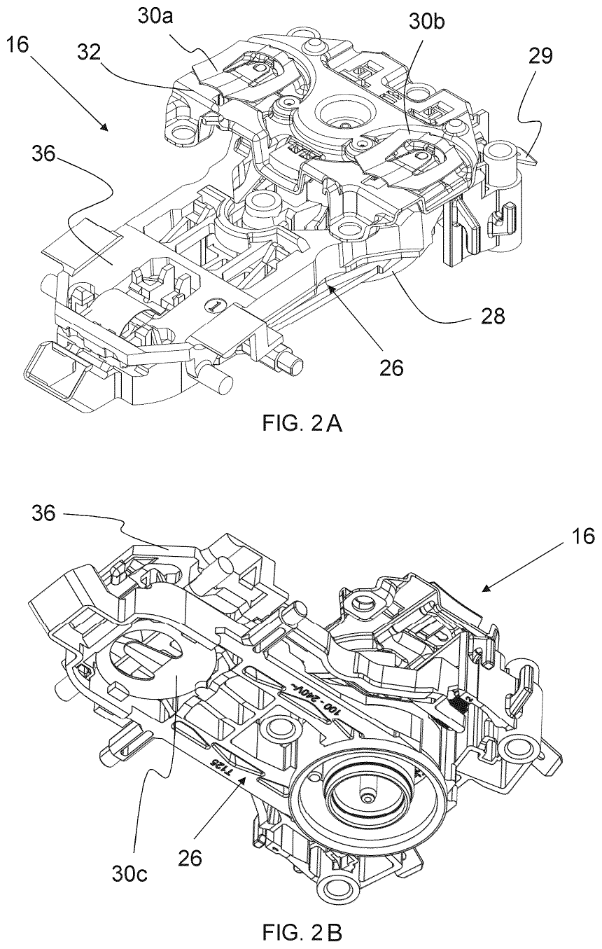

FIG. 2A shows a perspective view of the control unit 16 of the appliance 2 of FIG. 1.

The control unit 16 comprises a molded plastics control body 26 in which there is formed a cordless electrical adapter part 28 on its bottom side. The cordless electrical adapter part 28 is arranged to mate with the base electrical connector part 14 of the power base 12.

The control unit 16 comprises fixed electrical tabs 29, which are electrically connected to the cordless electrical adapter part 28 via a power supply circuit, which will be described in more detail below. As is known in the art, flying leads or other electrical connections can be made to the fixed electrical tabs 29 to connect the electrical power supply circuit to the electrical terminations of the electrical heater.

The control unit 16 further comprises a first thermally sensitive actuator 30a and a second thermally sensitive actuator 30b, supported by a metal mount plate 32 fixed on the top side of the control body 26. The thermally sensitive actuators 30a, 30b are snap-action bimetallic actuators, each set to operate independently at a predetermined temperature.

The actuators 30a, 30b are positioned on the top surface of the control unit 16 such that, when the control unit 16 is mounted to the underside of the heat diffuser plate, the actuators 30a, 30b are in thermally conductive communication with the diffuser plate. This means that the actuators 30a, 30b are arranged to detect the temperature of the diffuser plate.

As will be discussed in more detail below, the thermally sensitive actuators 30a, 30b are arranged such that their operation at the predetermined temperature(s) causes a switch within the control unit 16 to be opened, thereby interrupting the supply of electrical energy to the heater. As is known in the art, this allows the heater to be switched off in the event of a “dry-boil” scenario, in which no liquid is present within the liquid heating vessel 4.

The control unit 16 further comprises a trip lever 36 that is pivotally mounted on the control body 26 of the control unit 16 and is manually operable to open and close electrical contacts within the power supply circuit, as will be described in more detail below.

FIG. 2B shows a perspective view of the underside of the control unit 16 of the appliance 2 of FIG. 1.

The control unit 16 comprises a third thermally sensitive actuator 30c that is mounted on the control body 26 beneath a distal end of the trip lever 36. The proximal end of the trip lever is adjacent the first and second thermally sensitive actuators 30a, 30b and the electrical contacts of the power supply circuit.

The third thermally sensitive actuator 30c is in fluid communication with the liquid heating vessel 4 of the appliance 2 via a conduit (not shown) that extends, in this example, through the handle 8 of the appliance 2 such that steam generated within the liquid heating vessel 4 is directed towards the third thermally sensitive actuator 30c. The thermally sensitive actuator 30c is a snap-action bimetallic actuator set to operate at a predetermined temperature representative of liquid within the liquid heating vessel 4 having reached boiling temperature and having been converted into steam.

As will be described in more detail below, the thermally sensitive actuator 30c is arranged such that its operation at its predetermined temperature exerts a force on the distal end of the trip lever 36, causing the trip lever 36 to pivot into an “OFF” position, thereby opening the electrical contacts within the power supply circuit and interrupting the supply of electrical energy to the heater. As is known in the art, this allows the heater to be switched off when liquid in the liquid heating vessel 4 reaches boiling.

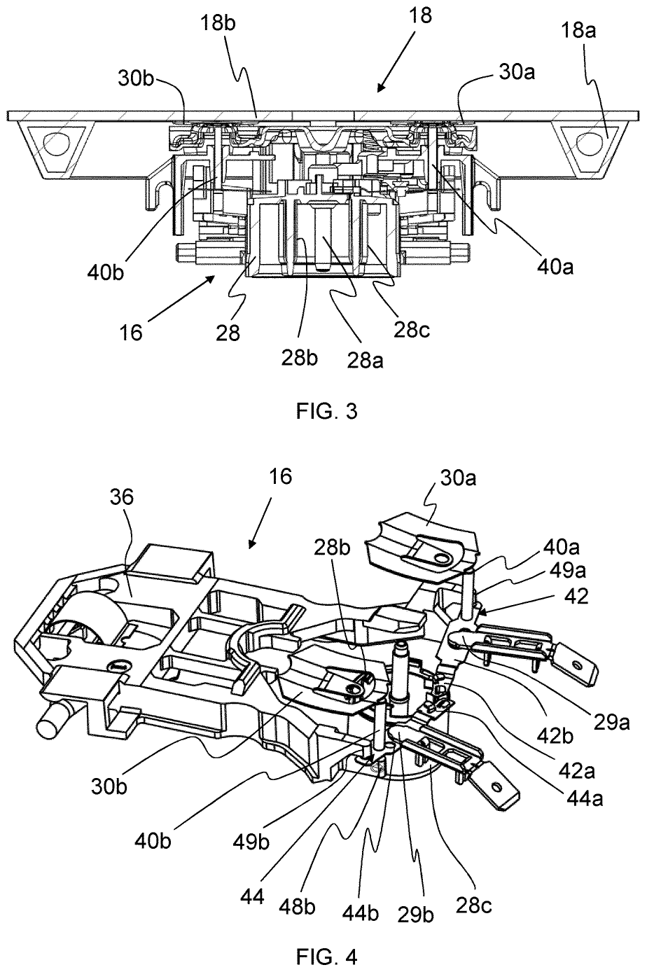

FIG. 3 shows a cross-sectional front view of the control unit 16 of FIGS. 2A and 2B, when mounted to the underside of a heat diffuser plate 18b of an electrical heater 18. The electrical heater 18 further comprises an electrical heating element 18a, also mounted to the underside of the heat diffuser plate 18b, that circumscribes the control unit 16.

The cordless electrical adapter part 28 is a 3-pole connector comprising an earth pin 28a, a live ring 28b and a neutral ring 28c. The live ring 28b and the neutral ring 28c are concentrically arranged around the central earth pin 28a. The base electrical connector (not shown in FIG. 3) comprises a central aperture to receive the earth pin 28a, a coaxial annular aperture to receive both the live ring 28b, and the neutral ring 28c.

Electrical contacts housed in the coaxial aperture contact the live ring 28b and neutral ring 28c respectively to connect the live and neutral poles of the power supply circuit when the connector parts 14, 28 are brought together. An electrical contact housed in the central aperture contacts the earth pin 28a.

The control unit 16 comprises a first push rod 40a and a second push rod 40b. The first push rod 40a is arranged directly below the first actuator 30a, and the second push rod 40b is arranged directly below the second actuator 30b. The first and second push rods 40a, 40b are arranged so as to be moved vertically downwards upon operation of the first and second actuators respectively 30a, 30b.

FIG. 4 shows a perspective partial view of the control unit of FIGS. 2A and 2B, in which a number of components of the control unit 16 have been removed for ease of illustration.

The control unit 16 comprises a live leaf spring 42 and a neutral leaf spring 44. The live leaf spring 42 comprises a fixed end 42a that is mounted to, and electrically connected to the live ring 28b. The live leaf spring 42 also comprises a moveable portion 42b, which extends from the point of deflection of the live leaf spring 42. The first push rod 40a is arranged to contact a distal end of the moveable portion 42b of the live leaf spring 42.

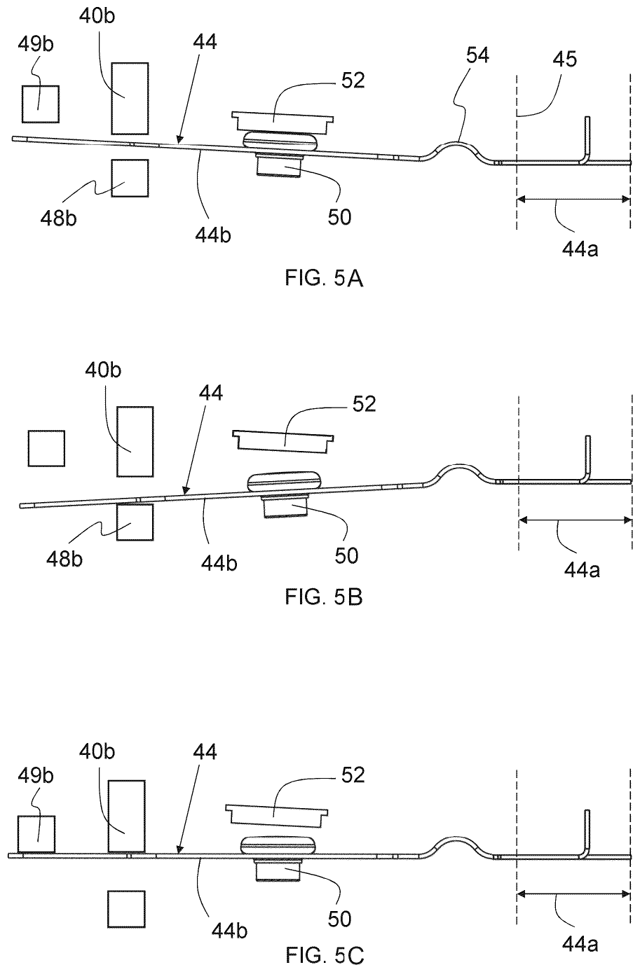

The neutral leaf spring 44 comprises a fixed end 44a that is mounted to, and electrically connected to, the neutral ring 28c. The neutral leaf spring 44 also comprises a moveable portion 44b, which extends from the point of deflection 45 of the neutral leaf spring 44 (shown in FIGS. 5A and 5B). The second push rod 40b is arranged to contact a distal end of the moveable portion 44b of the neutral leaf spring 44.

The live leaf spring 42 and the neutral leaf spring 44 are directly fixed to the live ring 28b and the neutral ring 28c respectively. The leaf springs 42, 44 comprise apertures for receiving corresponding tabs that protrude from the live and neutral rings 28b, 28c so as to facilitate this direct fixing.

The control unit 16 further comprises a live fixed tab 29a, positioned above the moveable portion 42b of the live leaf spring 42, and a neutral fixed tab 29b, positioned above the moveable portion 44b of the neutral leaf spring 44.

The leaf springs 42, 44 are arranged below the push rods 40a, 40b respectively such that, when the push rods 40a, 40b are moved downwards by the respective operation of the actuators 30a, 30b, the moveable portions 42b, 44b of the leaf springs 42, 44 are deflected downwards by the push rods 40a, 40b. The trip lever 36 of the control unit 16 comprises a force transfer pad 48b arranged below the moveable portion 44b of the neutral leaf spring 44 for transferring the downward movement of the push rod 40b, via the moveable portion 44b of the leaf spring 44 to the trip lever 36 which moves the trip lever 36 to the ‘OFF’ position whereby the contacts are then held in an open position by the stop 48a. The force transfer pad 48b is arranged directly below the push rod 40b. The trip lever 36 also comprises a force transfer pad (not shown in FIG. 4) arranged below the moveable portion 42b of the live leaf spring 42 for the same purpose.

The trip lever 36 also comprises return stops 49a, 49b arranged above the moveable portions 42b, 44b of the live and neutral leaf springs 42, 44 respectively for limiting the upward movement of the moveable portions 42b, 44b, as will be described in more detail below. The return stops 49a, 49b are arranged to contact and push down on the moveable portions 42b, 44b of the leaf springs 42, 44 when the trip lever 36 is pivoted to the “OFF” position, e.g. by manual operation of the trip lever 36 or as a result of the operation of the third thermally sensitive actuator 30c when steam is detected.

FIGS. 5A, 5B and 5C show cross-sectional front views of the neutral leaf spring 44 of the control unit 16 of FIGS. 2A and 2B. In FIG. 5A, the leaf spring 44 is in the closed position. FIG. 5B shows the leaf spring 44 after the push rod 40b has been moved downwards. FIG. 5C shows the leaf spring 44 in the open position.

The leaf spring 44 comprises a moveable electrical contact 50 that is mounted on the moveable portion 44b of the leaf spring 44 between the fixed end 44a and the portion of the leaf spring 44 arranged to be contacted by the push rod 40b. In the closed position, as shown in FIG. 5A, the moveable electrical contact 50 is in contact with a fixed electrical contact 52 of the neutral fixed tab 29b.

The leaf spring 44 is biased into the closed position (shown in FIG. 5A), meaning that the moveable electrical contact 50 is biased into contact with the fixed electrical contact 52 by the leaf spring 44.

As discussed above, when the second thermally sensitive actuator 30b operates, the push rod 40b is moved vertically downwards so as to bend the leaf spring 44 by deflecting the moveable portion 44b downwards relative to the fixed end 44a. As can be seen in FIG. 5B, owing to the force that the push rod 40b imparts to the moveable portion 44b, the moveable portion 44b of the leaf spring 44 continues to deflect downwards even after the push rod 40b has reached the end of its travel. The deflection of the moveable portion 44b is halted by the force transfer pad 48b of the trip lever 36, as shown in FIG. 5B.

This deflection causes the moveable electrical contact 50 to be separated from the fixed electrical contact 52. Thus, operation of the actuator 30b moves the leaf spring 44 into the open position (shown in FIGS. 5B and 5C). The force transfer pad 48b is pushed downwards by the leaf spring 44, thereby causing the trip lever 36 to pivot into the ‘OFF’ position. FIG. 5B shows the positions of the force transfer pad 48b and the stop 49b of the trip lever 36 before the trip lever has been moved into the ‘OFF’ position. FIG. 5C shows the positions of the force transfer pad 48b and the stop 49b with the trip lever 36 in the ‘OFF’position.

Owing to the resilience of the leaf spring 44, the moveable portion 44b of the leaf spring 44 then moves upwards relative to the fixed end 44a towards the closed position of the leaf spring 44. However, this causes the distal end of the leaf spring 44 to be brought back into contact with the end of the push rod 40b and with the return stop 49b of the trip lever 36 (which is now in the ‘OFF’ position). Thus, the return stop 49b and the push rod 40b hold the leaf spring 44 in its open position, in which the moveable electrical contact 50 is separated from the fixed electrical contact 52, as shown in FIG. 5C.

In order for the leaf spring 44 to be allowed to return to its closed position, it is necessary for the thermally sensitive actuator 30b to cool sufficiently so that it resets (thereby allowing the push rod 40b to be moved upwards) and for the user to pivot the trip lever to the ‘ON’ position, thereby lifting the return stop 49b out of contact with the leaf spring 44 and allowing the leaf spring 44 to move to the closed position (as shown in FIG. 5A). The force required to pivot the trip lever 36 is greater than the upwards force exerted by the moveable portion 44b of the leaf spring 44 on the return stop 49b as a result of the resilience of the leaf spring 44.

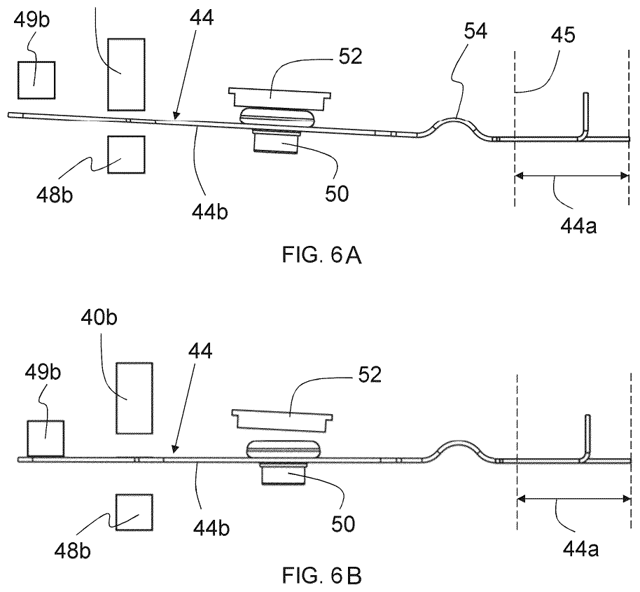

In addition to being movable into the open position by the push rod 40b after operation of the thermally sensitive actuator 30b, the leaf spring 44 is also movable into the open position by manual operation of the trip lever 36 or as a result of the operation of the third thermally sensitive actuator 30c causing the trip lever 36 to pivot when steam is detected. This is shown in FIGS. 6A and 6B.

FIG. 6A shows the same view of the neutral leaf spring 44 shown in FIG. 5A, in which the leaf spring 44 is in the closed position. FIG. 6B shows the leaf spring 44 after the trip lever 36 has been pivoted to the ‘OFF’ position. As discussed above, the trip lever 36 comprises the return stop 49b and the force transfer pad 48b, both of which are shown in FIGS. 6A and 6B.

As can been seen in FIG. 6B, instead of the push rod 40b being moved vertically downwards to contact and move the leaf spring 44, the trip lever 36 pivots such that the return stop 49b of the trip lever 36 is moved downwards and contacts the distal end of the moveable portion 44b of the leaf spring 44, causing the moveable portion 44b to deflect relative to the fixed end 44a so that the moveable electrical contact 50 is separated from the fixed electrical contact 52. The return stop 49b of the trip lever 36 holds the leaf spring 44 in this open position. In order for the leaf spring 44 to be allowed to return to its closed position (shown in FIG. 6A), the user pivots the trip lever to the ‘ON’ position, thereby lifting the return stop 49b out of contact with the leaf spring 44 and allowing the leaf spring 44 to move to the closed position.

The vertical travel of the push rod 40b is substantially equal to the vertical distance through which the thermally sensitive actuator 30b travels when it operates. The vertical travel of the moveable portion 44b of the leaf spring 44, at the point at which the push rod 40b contacts the leaf spring 44 (i.e. the ‘contact point’), is substantially equal to the distance through which the deflecting part of the thermally sensitive actuator 30b travels when it operates. The vertical movement of the moveable electrical contact 50 depends on the relative distances between the deflection point 45, the moveable electrical contact 50 and the push rod 40b. As the push rod 40b is arranged to contact the leaf spring 44 at a point along the leaf spring 44 that is more distal than the moveable electrical contact 50, the moveable electrical contact 50 is moved through a distance that is less than the distance travelled by the push rod 40b. This means that, although the leaf spring of the present invention can be shorter than conventional leaf springs, existing thermally sensitive actuators can nevertheless be used with embodiments of the present invention without requiring that the thermally sensitive actuators be modified to provide a shorter travel distance.

As the leaf spring 44 is thinner than conventional leaf springs, it may also be less stiff, meaning that the leaf spring 44 may over-travel after operation of the thermally sensitive actuator 30b. This over-travel can cause the stresses induced in the leaf spring to exceed the yield stress of the leaf spring material. The force transfer pad 48b prevents over-travel of the leaf spring 44 via the inertia of the trip lever 36 when the leaf spring 44 is deflected by the thermally sensitive actuator 30b via the push rod 40b. The thermally sensitive actuator 30b can impart a high dynamic mechanical load on the leaf spring 44. However, by preventing over-travel of the leaf spring 44, the stress on the leaf spring 44 can be limited. When the force transfer pad 48b is arranged on the trip lever 36, as discussed above, the impact between the leaf spring 44 and the force transfer pad 48b also causes the trip lever 36 to pivot to an OFF position, thereby resetting the trip lever 36.

The leaf spring 44 comprises a kink 54 arranged adjacent the deflection point 45 between the fixed end 44a and the moveable portion 44b of the leaf spring 44. The kink 54 is substantially sinusoidal in cross-section, extending in an arc out of the plane of the leaf spring 44 and returning to substantially the same plane (i.e. corresponding to approximately half a sine wave). The curved cross-section of the leaf spring 44 comprises a fillet on either side of the arc of the kink 54, thereby rounding the intersections of the geometries of the sinusoidal kink 54 and the flat leaf spring 44.

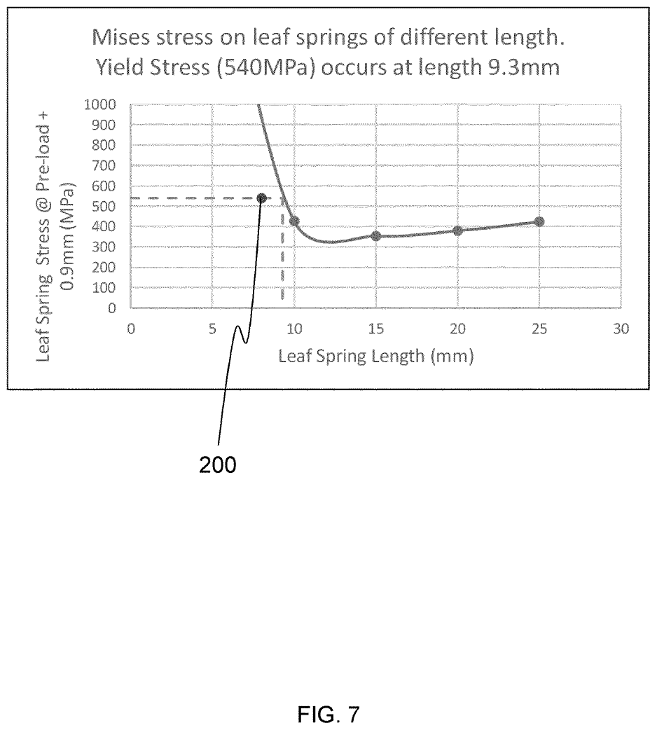

FIG. 7 shows a graph of the von Mises stress in straight (i.e. conventional) leaf springs of 0.15 mm thickness and different lengths with a deflection of 0.9 mm applied, corresponding to the deflection when the leaf spring is deflected by a push rod.

It can be seen that, for a conventional leaf spring with a yield stress of 540 MPa, the minimum length that the leaf spring can be without exceeding the yield stress when deflected by 0.9 mm is 9 mm.

FIG. 7 also shows a dot 200 representing the von Mises stress in a 0.15 mm thick leaf spring comprising a kink according to the present invention. As can be seen, by incorporating a kink into the shape of the leaf spring, a leaf spring with a footprint length of 8 mm can be used without exceeding the yield stress of the material. This is because the kink can increase the effective bending length of the leaf spring, thereby helping to decrease the maximum induced stress, without increasing the footprint length of the leaf spring.

The leaf spring 44 shown in FIGS. 4, 5 and 6 is approximately 22 mm in length, approximately 3.5 mm wide and approximately 0.15 mm thick. The material of the leaf spring 44 is C 7025, a hardened copper alloy, with a yield stress of approximately 540 MPa. The radius of curvature of the arc of the kink 54 is 0.8 mm, and the radii of curvature of the fillets on either side of the kink 54 are 0.65 mm.

The leaf spring 44 is shaped to provide a pre-load of 20 grams on the fixed electrical contact 52. Upon operation of the thermally sensitive actuator 30b, the moveable electrical contact 50 is separated from the fixed electrical contact 52 by 0.9 mm to sever the electrical connection between the contacts 50, 52.

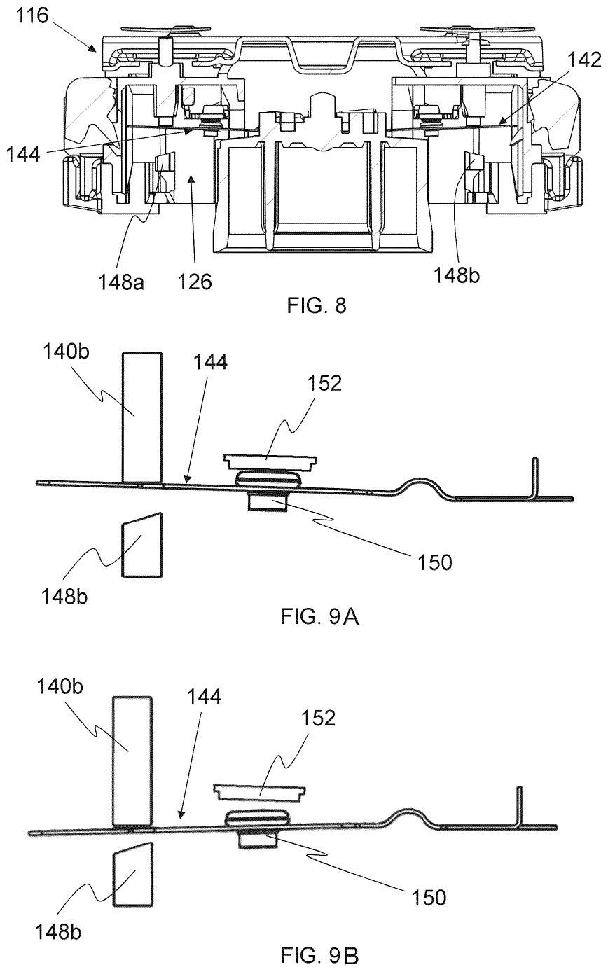

FIG. 8 shows a cross-sectional front view of a control unit 116 in accordance with another embodiment of the present invention. FIGS. 2 to 6 show an “integrated” control unit 16, in which the control unit 16 itself comprises a mechanism for interrupting the power supply circuit in an overheat condition (i.e. thermally sensitive actuators 30a, 30b) as well as a mechanism for interrupting the power supply circuit when a liquid temperature condition (e.g. boiling) is reached (thermally sensitive actuator 30c).

The control unit 116 of FIG. 8, however, comprises only an ‘overheat’ protection mechanism. While, in the integrated control unit 16 of FIGS. 2 to 5, the ‘overheat’ detecting thermally sensitive actuators 30a, 30b and the ‘liquid temperature condition’ detecting thermally sensitive actuator 30c are arranged to open the same set of electrical contacts 50, 52, the control unit 116 of FIG. 8 is suitable for use in an appliance in which the ‘overheat’ detection mechanism and the ‘liquid temperature condition’ mechanism open different sets of electrical contacts.

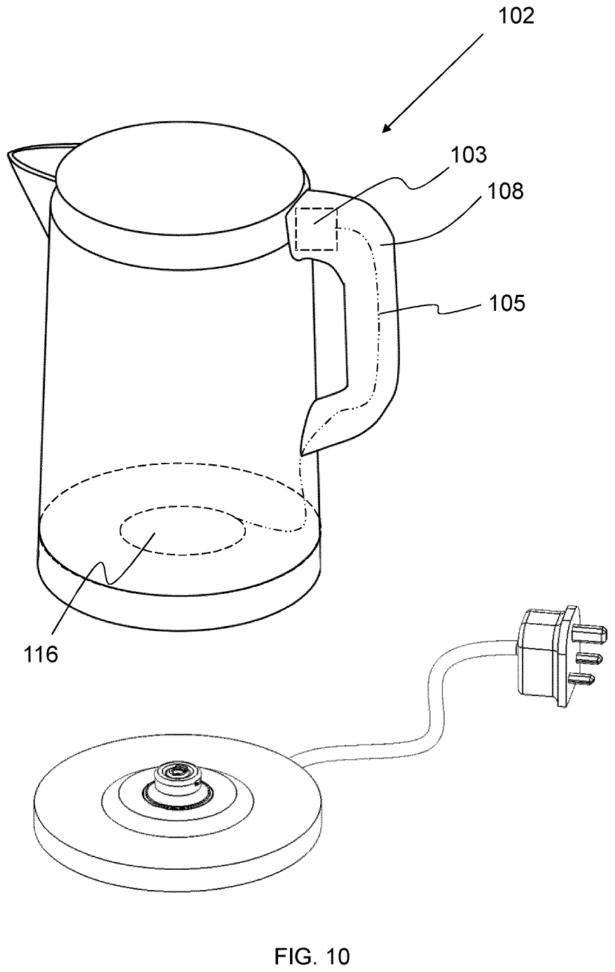

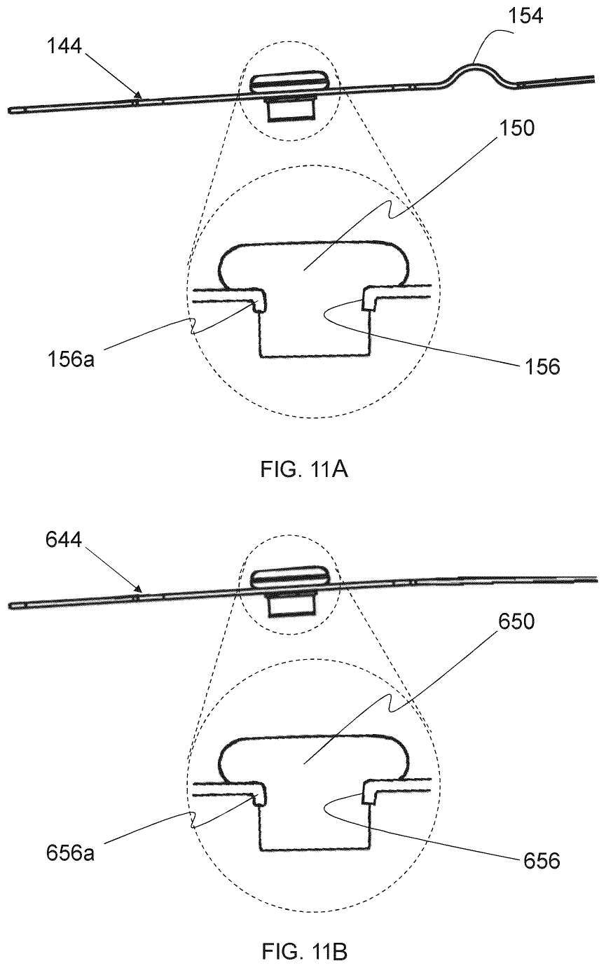

FIG. 10 shows an example of such an appliance 102, comprising the control unit 116 of FIG. 8. The appliance 102 is a “split-switch” appliance, in which a separate electrical switching arrangement 103 is provided for interrupting the power supply circuit when a liquid temperature condition is reached. The electrical switching arrangement 103 is arranged separately from the control unit 116, which comprises the ‘overheat’detection mechanism.

The separate electrical switching arrangement 103 comprises a steam-sensitive bimetallic element (not shown), that is located at the top of the handle 108. The electrical switching arrangement 103 is electrically connected to the control unit 116 by electrical cables 105 that extend through the handle 108 of the appliance 102. The separate electrical switching arrangement 103, the electrical heater (not shown), and the control unit 116, are electrically connected in series.

The control unit 116 does not comprise a trip lever, so instead of force transfer pads 48a, 48b, the control unit 116 of FIG. 8 comprises stops 148a, 148b that are arranged on the molded control body 126 of the control unit 116, to prevent overshoot deflection of the live and neutral leaf springs 142, 144 respectively. The other components of the control unit 116 are essentially the same as the control unit 16 of FIGS. 2 to 6.

FIGS. 9A and 9B show front views of components of the control unit 116 of FIG. 8.

FIG. 9A shows the neutral leaf spring 144 in the closed position, in which the moveable electrical contact 150 is in contact with the fixed electrical contact 152. FIG. 9B shows the leaf spring 144 in the open position, after the push rod 140b has been moved downward by the thermally sensitive actuator towards the stop 148b. In the open position, the moveable electrical contact 150 is separated from the fixed electrical contact 152 by 0.9 mm to sever the electrical connection between the contacts 150, 152.

FIG. 11A shows a front view and an enlarged cross-sectional front view of the mounting arrangement of the moveable electrical contact 150 of the leaf spring 144 shown in FIGS. 9A and 9B. The leaf spring 144 includes a kink 154 as previously described.

The leaf spring 144 defines a punched aperture 156 for receiving the moveable electrical contact 150. The moveable electrical contact 150 is received within the aperture 156 by a press fitting. As the aperture 156 is punched in the leaf spring 144, the perimeter 156a of the aperture 156 bends downwards out of the plane of the leaf spring 144, meaning that a high surface area of the leaf spring 144 is in contact with the moveable electrical contact 150 when the contact 150 is received within the aperture 156. This means that, although the leaf spring 144 is thinner than conventional leaf springs, the contact surface area between the leaf spring 144 and the moveable electrical contact 150 can remain the same, meaning that the flow of current between the leaf spring 144 and the moveable electrical contact 150 is substantially unaffected by the thinning of the leaf spring.

Furthermore, this process also forms a stiff cylindrical structure within the leaf spring 144 at the point of contact between the moveable electrical contact 150 and the fixed electrical contact 152. This helps to counter-act any reduction in the stiffness of the leaf spring 144 resulting from the relatively reduced thickness of the leaf spring 144 in comparison with known leaf springs and helps to ensure a strong cold bond can be formed between the moveable electrical contact 150 and the leaf spring 144. As a result, more of the force provided by the leaf spring 144 can be transferred to electrical contacts 150, 152 to close the electrical contacts 150, 152.

It will be appreciated that the mounting arrangement of the moveable electrical contact 150 shown in FIG. 11A and described above may equally be applied to either of the leaf springs 42, 44 of the embodiments shown in FIGS. 2 to 6.

The mounting arrangement may also be applied to leaf springs that do not include a kink, in accordance with another aspect of the present invention. FIG. 11B shows an example of such an arrangement, in which a substantially planar leaf spring 644 defines an aperture 656 in which an electrical contact 650 is arranged. The perimeter 656a of the aperture 656 bends downwards out of the plane of the leaf spring 644.

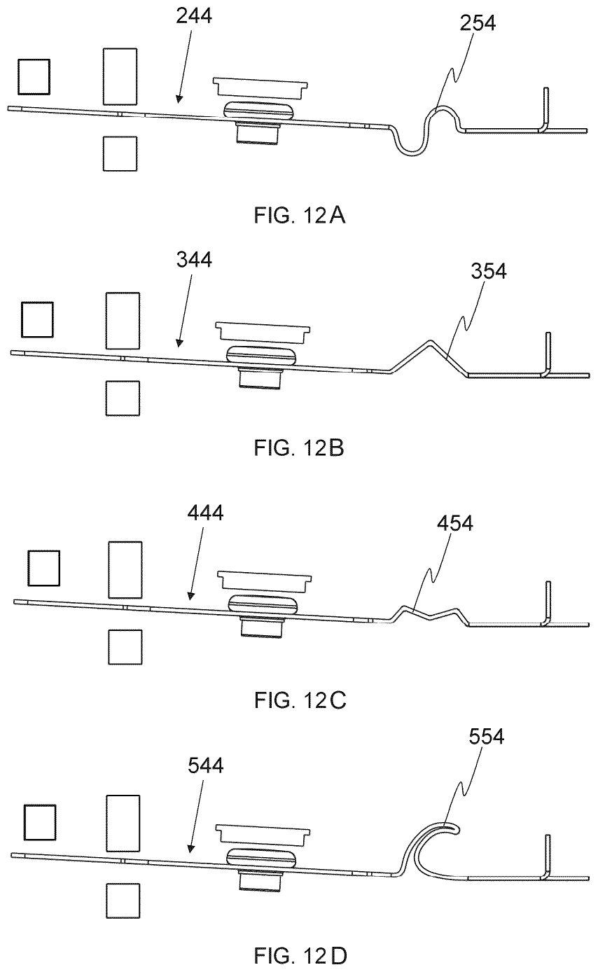

Although the embodiments described above and shown in FIGS. 2 to 11A feature leaf springs with kinks that correspond to approximately half a sine wave, many alternative geometries of kink can be used in order to provide the same effect of increasing the effective bending length of the leaf spring. Some examples of alternative geometries are shown in FIGS. 12A, 12B, 12C and 12D.

FIG. 12A shows an alternative leaf spring 244 comprising an S-shaped or sinusoidal kink 254, i.e. corresponding to a full period of a sine wave.

FIG. 12B shows an alternative leaf spring 344 comprising an inverted ‘V’-shaped kink 354. The kink 354 extends linearly and diagonally out of the plane of the leaf spring 344 to a peak, and returns symmetrically to the plane of the leaf spring 344.

FIG. 12C shows an alternative leaf spring 444 comprising a substantially ‘M’-shaped kink 454. The ‘M’-shaped kink is similar to the inverted ‘V’-shaped kink 354 of FIG. 12B, except that the peak itself is inverted so as to form two peaks with a valley portion arranged therebetween.

FIG. 12D shows an alternative leaf spring 544 comprising a folded kink 554. The kink 554 curves upwards out of the plane of the leaf spring 544 through an angle of approximately 180°, and then once again continues in the distal direction over the crest of the curve to return to the plane of the leaf spring 544. The folded kink 554 thus substantially resembles the shape of a breaking wave.

The skilled person will appreciate that many further alternative kink geometries, in addition to those illustrated and described herein, may be suitable.

What is claimed is:

1. A control unit for controlling an electrical power supply circuit to an electrical heater in a liquid heating appliance, the control unit comprising:
a leaf spring comprising a fixed end and a moveable portion that is moveable relative to the fixed end between a closed position and an open position;
a moveable electrical contact, mounted on the moveable portion of the leaf spring, mating with a corresponding fixed electrical contact in the electrical power supply circuit when the leaf spring is in the closed position;
a thermally sensitive actuator, operable at a predetermined temperature to move the moveable portion of the leaf spring from the closed position to the open position in which the moveable electrical contact is separated from the fixed electrical contact to interrupt the electrical power supply circuit;
wherein the leaf spring comprises a kink between the fixed end and the moveable portion.

2. The control unit of claim 1, further comprising a cordless electrical adapter part for mating with a corresponding base electrical connector part to receive a supply of electrical power, the cordless electrical adapter part comprising a mating conductor for connecting to a live or neutral pole of a corresponding base electrical connector part, wherein the fixed end of the leaf spring is directly fixed to the mating conductor of the cordless electrical adapter part.

3. The control unit of claim 2, wherein the cordless electrical adapter part and corresponding base electrical connector part are of the type that can be mated regardless of their relative angular orientation.

4. The control unit of claim 1, wherein the kink is arranged adjacent the fixed end at the point of deflection of the leaf spring.

5. The control unit of claim 1, wherein the kink is continuously curved.

6. The control unit of claim 5, wherein the kink comprises an arcuate portion arranged between two fillets.

7. The control unit of claim 1, wherein the kink extends out of the plane of the leaf spring and returns substantially to the same plane.

8. The control unit of claim 1, wherein the thermally sensitive actuator is arranged to push against a contact point of the moveable portion of the leaf spring to move the moveable portion from the closed position to the open position, and wherein the moveable electrical contact is mounted on the moveable portion of the leaf spring between the kink and the contact point.

9-11. (canceled)

12. The control unit of claim 1, further comprising a stop for arresting the movement of the moveable portion of the leaf spring after the moveable portion has moved from the closed position to the open position.

13. The control unit of claim 12, further comprising a trip lever for allowing a user to manually move the moveable portion of the leaf spring from the closed position to the open position and/or from the open position to the closed position, wherein the stop is arranged on the trip lever.

14. A liquid heating appliance comprising:
a liquid heating vessel;
an electrical heater for heating liquid contained within the liquid heating vessel, wherein the electrical heater is powered by an electrical power supply circuit; and
a control unit as claimed in claim 1.

15. The liquid heating appliance of claim 14, further comprising an electrical switching arrangement that is physically separate from, but electrically connected to, the control unit, wherein:
the electrical switching arrangement comprises a liquid-temperature-condition thermally sensitive actuator that is arranged to open the switch so as to interrupt the supply of power to the heater when a predetermined temperature is detected corresponding to a desired state for the liquid in the liquid heating volume; and
the thermally sensitive actuator of the control unit comprises an overheat thermally sensitive actuator, wherein the predetermined temperature at which the overheat thermally sensitive actuator is arranged to operate corresponds to a temperature within the liquid heating appliance during an overheat scenario.

16. The liquid heating appliance of claim 15, wherein the electrical switching arrangement is arranged in a different part of the liquid heating appliance to the control unit.

17. The control unit of claim 1, wherein:
the thermally sensitive actuator of the control unit comprises an overheat thermally sensitive actuator, wherein the predetermined temperature at which the overheat thermally sensitive actuator is arranged to operate corresponds to a temperature within the liquid heating appliance during an overheat scenario; and
the control unit further comprises a liquid-temperature-condition thermally sensitive actuator that is arranged to separate the moveable electrical contact from the fixed electrical contact so as to interrupt the electrical power supply circuit when a predetermined temperature is detected corresponding to a desired state for the liquid in the liquid heating volume.

18. The control unit of claim 17, further comprising a trip lever that is moveable so as to act on and move the moveable portion of the leaf spring from the closed position to the open position, wherein the liquid-temperature-condition thermally sensitive actuator is arranged to move the trip lever at the predetermined temperature so as to move the moveable portion of the leaf spring from the closed position to the open position in which the moveable electrical contact is separated from the fixed electrical contact to interrupt the electrical power supply circuit.

19-44. (canceled)

45. A leaf spring comprising:
a proximal end and a distal portion that is moveable relative to the proximal end; and
an electrical contact, mounted on the distal portion of the leaf spring, for mating with a corresponding electrical contact;
wherein the leaf spring defines an aperture in which the electrical contact of the leaf spring is arranged, and wherein the leaf spring comprises a protrusion that extends out of the plane of the leaf spring around the perimeter of the aperture to surround the electrical contact.

46. The leaf spring of claim 45, wherein the leaf spring is between 0.05 mm and 0.18 mm thick

47. The leaf spring of claim 46, wherein the leaf spring is approximately 0.15 mm thick.

48. The leaf spring of claim 45, wherein the electrical contact of the leaf spring is arranged within the aperture by an interference fit.

49. The leaf spring of claim 45, wherein the leaf spring is a monolithic component comprising the protrusion.

50. (canceled)
